(19) United States
(12) Patent Application Publication
(10) Pub. No.: US 2015/0281930 A1
(43) Pub. Date: Oct. 1, 2015

(54) MOBILE PERSONAL SECURITY SYSTEM

(71) Applicant: Tamar BEN-PORATH, Herzeliya (IL)

(72) Inventor: Tamar BEN-PORATH, Herzeliya (IL)

(21) Appl. No.: 14/294,758

(22) Filed: Jun. 3, 2014

Related U.S. Application Data
(60) Provisional application No. 61/831,670, filed on Jun. 6, 2013.

(51) Int. Cl. H04W 4/22; H04W 4/02

(52) U.S. Cl. CPC H04W 4/22; H04W 4/027; H04W 88/02

(57) ABSTRACT

A mobile personal security device, system and method are disclosed. The personal security device and system may include a portable communication or computing device having a positioning device, and adapted to communicate with a server to provide location based information and alerts to an Emergency Call Center (ECC), operate an imaging system of the portable device to obtain images and send them to the server via a network, set an alarm and play a recorded notice when an indication of an emergency is received from a user. A method according to one embodiment comprises initiating a personal security application on the portable device, providing a fixed location of a user or locating a user and tracking the user's location via a positioning device, translating the received position or positions to an address or a route of the user, and upon indication of emergency, automatically call an ECC, initiate an alarm, play a recorded notice and/or obtain images, via a front and/or rear imagers of the portable computing or communication device and send the images to a remote server via a communication network.

### CROSS REFERENCE TO RELATED APPLICATIONS

This application claims the benefit of U.S. Provisional Patent Application Ser. No. 61/831,670, filed on Jun. 6, 2013, and entitled “MOBILE PERSONAL SECURITY SYSTEM, incorporated in its entirety herein by reference.

### SUMMARY OF THE INVENTION

Embodiments of the present invention provide a device, system and method for personal security purposes. According to some embodiments of the present invention, a mobile application for personal security purposes is presented. The mobile application may be connected to a server. The application may have a plurality of operation modes. For example, according to some embodiments, the mobile application may have two basic modes of operation: “walk me”—while user is moving and “guard me”—while user is staying at a fixed location.

According to some embodiments the personal security device and system may include a portable communication or computing device having a positioning device, and adapted to communicate with a server to provide location based information and alerts to an Emergency Call Center (ECC), operate an imaging system of the portable device to obtain images and send them to the server via a network, set an alarm and play a recorded notice when an indication of an emergency is received from a user.

A method according to one embodiment comprises initiating a personal security application on the portable device, providing a fixed location of a user or locating a user and tracking the user's location via a positioning device, translating the received position or positions to an address or a route of the user, and upon indication of emergency, automatically call an ECC, initiate an alarm, play a recorded notice and/or obtain images, via a front and/or rear imagers of the portable computing or communication device and send the images to a remote server via a communication network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary illustration of a portable device displaying the main screen of mobile application according to embodiments of the present invention;

FIG. 2 is an exemplary screen of the mobile application of FIG. 1 in one operation mode according to an embodiment of the present invention;

FIG. 3 is an exemplary screen of the mobile application of FIG. 1 in another operation mode according to embodiments of the present invention;

FIG. 4 is another illustration of a password screen of a mobile application according to embodiments of the present invention; and

FIG. 5A and 5B are flowcharts of methods according to embodiments of the present invention in one alert mode.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to some embodiments of the present invention, a mobile application for personal security purposes is presented. The mobile application may be connected to a server. The application may have a plurality of operation modes. For example, according to some embodiments, the mobile application may have two basic modes of operation: “walk me”—while user is moving and “guard me”—while user is staying at a fixed location.

The “walk me” status has location based functionality. Once operated, the location of the handset will be shown at the server, and “translated” to a specific address if can be identified by a mapping application such as google maps. The mobile application enables using the handset as a location based emergency button—by a single click the application may activate functionalities to deter a potential attacker. Additionally, the mobile application connects the user by one single click to an emergency call center. According to different set of rules, the mobile application may send (for example via email or SMS) different messages to the emergency call center to describe the user's current emergency status. The mobile application also allows the user, while in a move, to activate “check in” status (called RuOK Alert status), by which the emergency center may get a notice of emergency status, even if the user was unable to click to contact the emergency call center.

Download and Registration Process

Following the free download of the mobile application to the user's handset, the user will get free access to the Alarm Siren functionality. In order to activate the services that are related to the Emergency Center (location based services, call and notifications to Emergency Center), certain functionalities within the Alarm service such as recorded message and photos and the RuOK alert status (such services are collectively referred to as “Premium Services”), the user will need to complete a registration process by which the user will insert, inter alia, the following details:
full name,
cellular number,
OK password (PW)—2 digits
Emergency PW—2 digits (optional)
Identification code (4-8 letters; for example name of a country)—to enable the Emergency Call Center (ECC) to verify the identity of the user while calling to the Emergency Center.
Emergency code (4-8 letters; for example name of a city) (optional)—while calling the Emergency Center, the user can identify himself with Emergency code, which will indicate to the Emergency Center that the user is under danger.
Fixed address 1 for “walk me” status (optional)
Fixed address 2 for “walk me” status (optional)
Time interval for RuOK Alert status (optional)

All details inserted during the registration process are sent to and are saved at the server.

Manner of Operation

Following the successful completion of the registration process, the user can activate the Premium Services.

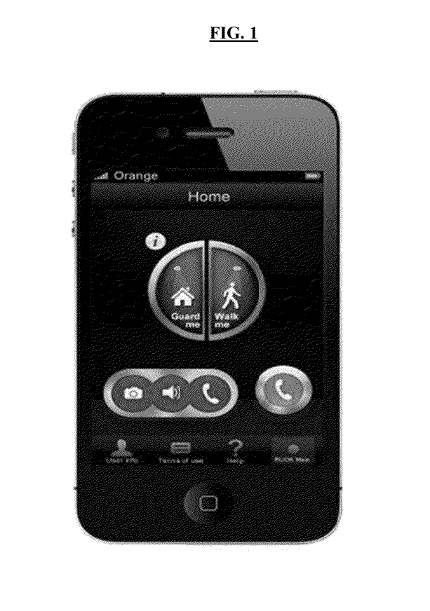

Each time the application is activated, the user needs to select one of 2 modes of operation: “walk me”—if the user is on a move (in the main screen illustrated in FIG. 1—right side on the main button with a picture of a walking man) or “guard me” (in the main screen illustrated in FIG. 1—left side on the main button with a picture of a house)—if the user is staying at a fixed address during the respective time session of operating the application.

Walk Me′Operation mode:

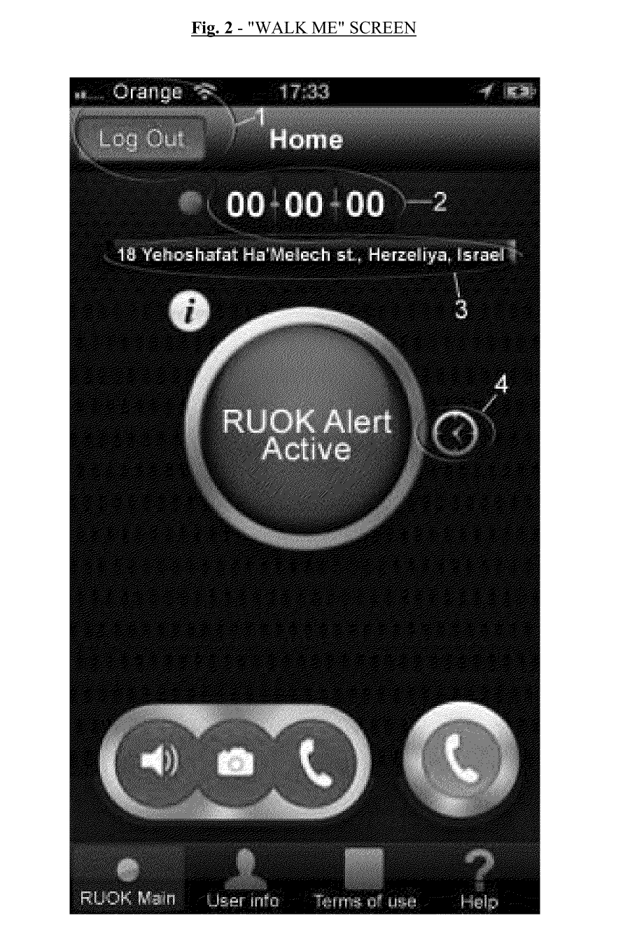

If the user selected “walk me” mode—a notice will be sent to the server. In addition the location based functionality will be activated and the location of the user/handset will be sent to the server within the time intervals determined by the server and“translated” to an address if the location can be identified at an address at google maps . The address will be shown on the main screen (see element 3 in FIG. 2), and will be updated within time intervals set by the server.

Once the “Walk Me” mode is activated—a timer (marked “2” in FIG. 2 below)—will show the time period of using the “Walk Me” mode.

In the “Walk Me” mode of operation, the user may select to activate the RuOK Alert status (FIG. 2—main button in the middle). RuOK Alert status is described below.

“Guard Me” Operation Mode:

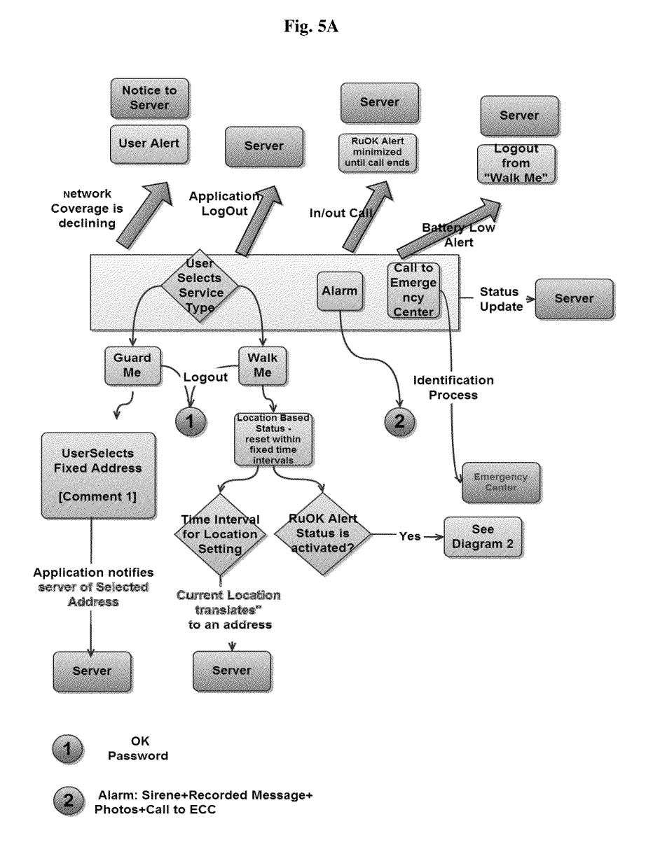

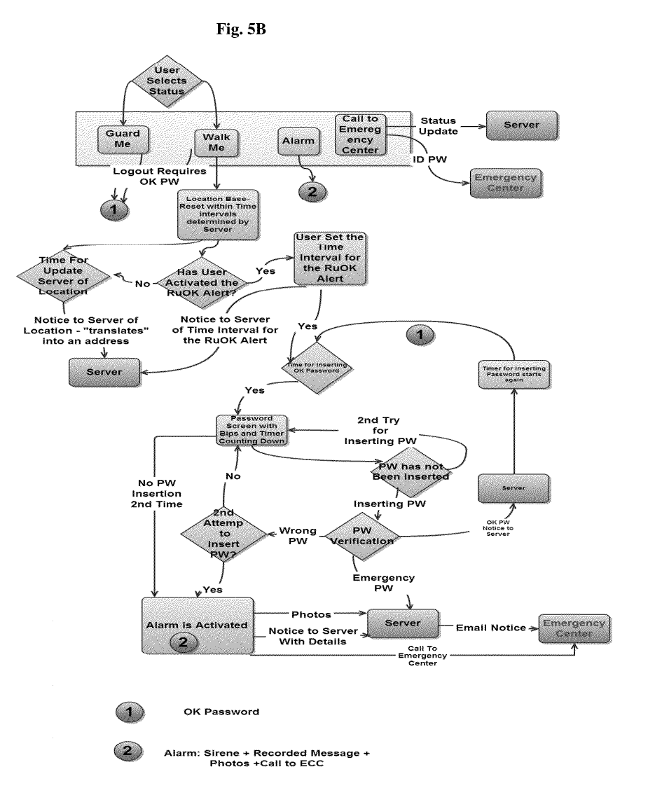

If the user selected “guard me” mode—the application will offer user four potential options for a fixed address [comment 1 in FIG. 5A], as follows:

First Fixed Address inserted by the user in the registration process
Second Fixed Address inserted by the user in the registration process.
The user can insert in the Settings screen two addresses; for example home address and address of a boyfriend; the insertion of addresses is optional
Current location according to location based services
Other address to be inserted manually

The user must select one of the four options in order to activate the “Guard Me” mode. The selection of the fixed address will be sent to the Server and“translated” to an address if the location can be identified at an address at google maps. Each time the “Guard Me” mode is activated the user will need to select a fixed address; yet during the respective time of the mode, i.e.upon activation of the “Guard Me” mode and until user logout from the “Guard Me” mode—the user location will not be updated at the server, whether or not the user changed his location.

Once the “Guard Me” mode has been activated, the user can operate the Alarm and the Call Emergency Center functionalities. In both cases the Emergency Center knows the location of the user as specified above.

“Alarm”

The Alarm can be activated both in the “guard me” and “walk me” mode of operation by a single click on the Alarm icon. The Alarm icon includes an illustration of Siren, camera and call to reflect the different functionalities.

By activating the Alarm, the following actions will take place:

Notice will be sent to the server that the alarm was activated
Siren will be heard
Recorded message will be heard (following the Siren)
Front and back camera of the handset, will take photos by rotation between front and back camera and photos will be sent to and saved on the server.
Automatic dial (without the need for additional click) to the ECC (following the recorded message).

Upon activation of the Alarm, the server will send a notice (via e-mail or SMS) to the ECC. Accordingly, in case that the automatic call to the ECC will not be completed, the ECC will get anyway a notice of the activation of the Alarm.

“Call Emergency Center”

The “Call Emergency Center” icon can be activated in the “guard me” and “walk me” mode of operations.

By clicking the Call Emergency Center icon—the application will automatically dial to the Emergency Center. This functionality is intended to a situation in which the user does not want to operate all the Alarm functionalities (Siren, recorded message, camera etc.) but wish only to contact the Emergency Call Center). In addition a notice will be sent to the Server.

The Emergency Center will identify the user based upon his cellular number and verify the identification by asking the user for his identification code (inserted in the registration process and recorded in the server). The ECC has a link to the system server.

“”Logout”

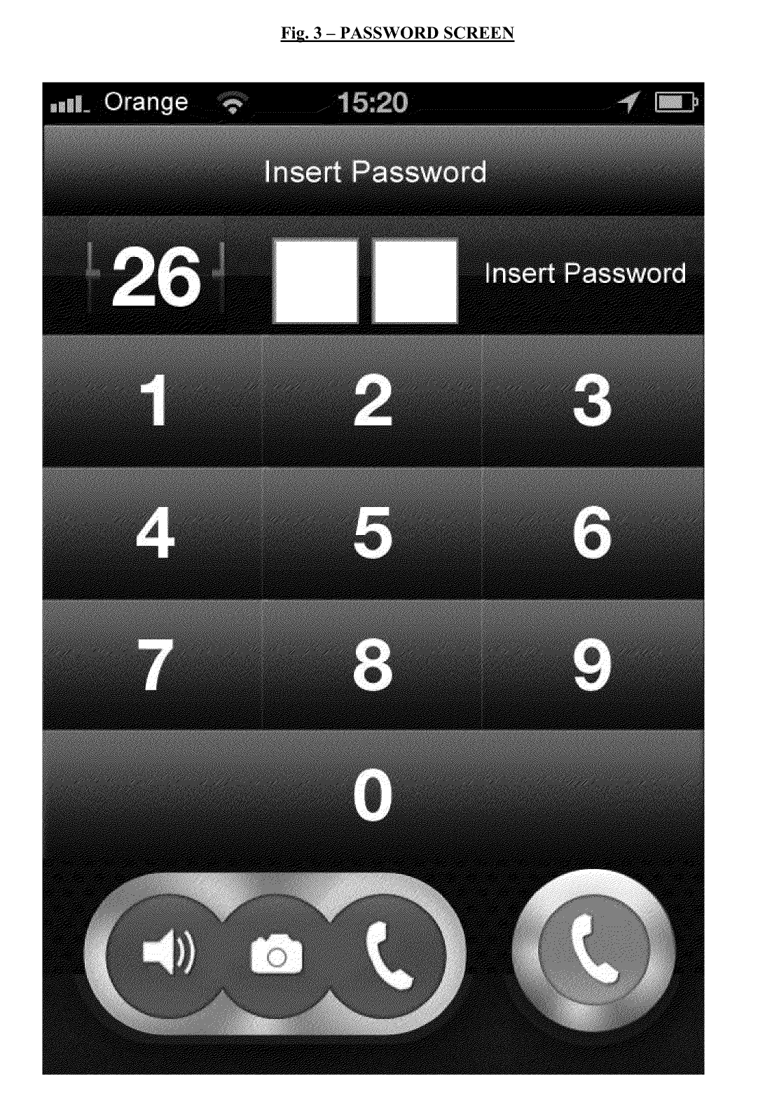

The logout from any mode of operation of the application, including stopping Alarm operation will require the user to insert the OK Password (2 digits). (The logout icon in the “Walk Me” status is marked “1” in FIG. 2 and same icon appears in the “Guard Me” status screen). Once user clicks the logout icon, the password screen (FIGS. 3 & 4 below) will show up and require the user to insert the OK password. Successful logout will be notified to the server.

Notice from Server to Emergency Call

The Emergency Center can be contacted either by a call from user or by a notice (email or SMS) from Server to Emergency Center.

The call can be initiated in two ways—directly by clicking the “Call Emergency Center” icon or by clicking the Alarm icon, in which case the call to the Emergency Center will be initiated automatically (without the need for additional click) following certain Alarm functionalities (Siren, recorded messages and photos);

Notice by e-mail or SMS will be sent by server to Emergency Center in various scenarios which are intended to cover cases of emergency in which the user may not be able to call the Emergency Center directly or through the Alarm automatic dial.

In the following scenarios, a notice will be sent to the Emergency Center:

Scenario 1—Alarm was activated by user. The notice is sent immediately upon activating the Alarm, so that in the event that the automatic call to the Emergency Center will not be completed, the Emergency Center will be notified any way of the emergency situation.

Scenario 2—user is in “Walk Me” mode, activated the RuOK Alert status and inserted an emergency password (see further explanation of RuOK Alert below);

Scenario 3—user is in “Walk Me” mode, has activated the RuOK Alert status and has not inserted the OK password two times (see further explanation of RuOK Alert below);

Scenario 4—user is in “Walk Me” mode, has activated the RuOK Alert status and inserted an unidentified password, i.e. password that is not defined in the application as an OK password or an emergency password (see further explanation of RuOK Alert below).

All notices from Server to Emergency Center will include user's phone number. The details of the specific incidence are (one of the scenarios listed above) are recorded in the server so to enable the Emergency Center to better handle the emergency incident.

Low Battery

In case the handset remaining battery is low (5%) the application will log out by itself. Before logout, a notice (pop up) will show up to the user—see FIG. 5A.

RuOK Alert:

Once the “Walk Me” mode of operation is activated, the mobile application will enable the user to select whether or not to activate the RuOK Alert.

In the RuOK Alert status is activated, the mobile application will check whether or not the user is OK, within a time interval set by the user.

The time interval can be set during the registration process. It can also be set by user at a later stage through the Setting Screen in the mobile application.

Alternatively the time interval can be set or changed through the RuOK Alert status screen by clicking the “clock” icon (see FIG. 2—“clock” icon marked “4”). Once the RuOK is activated, notice will be sent to the server (including time interval settings).

Once activated—the mobile application will check whether the user is OK, by showing a screen in which the user needs to feed a password (the Password Screen—FIG. 3 below).

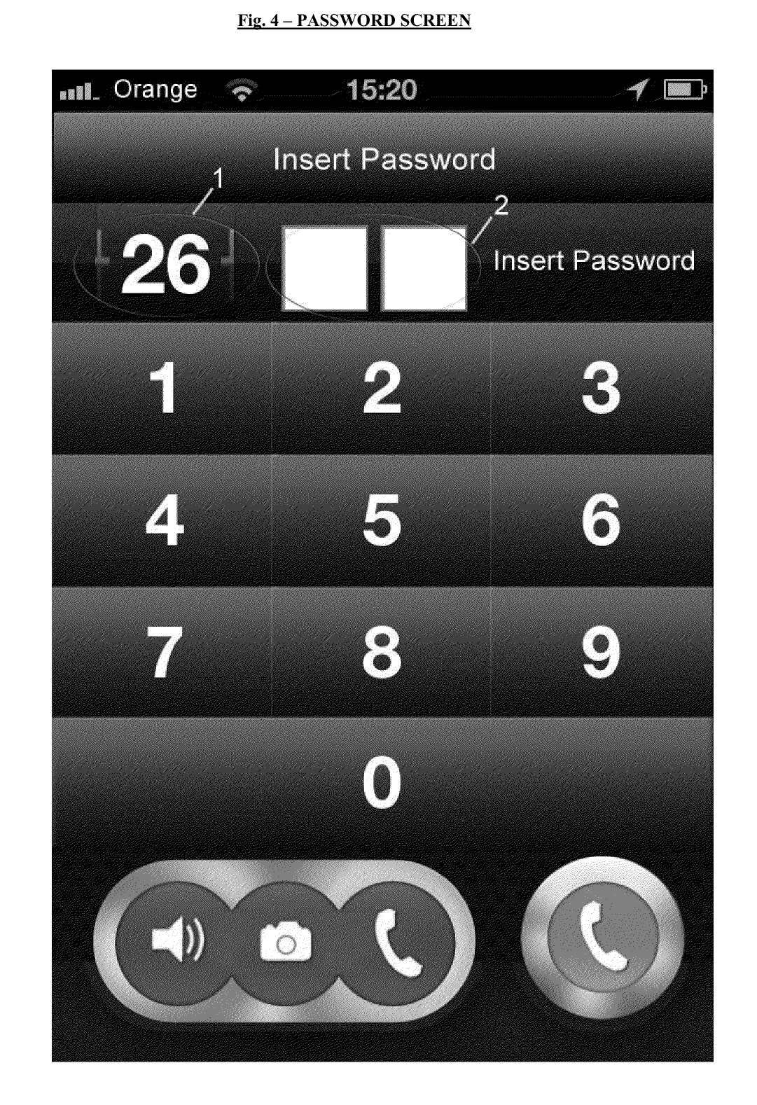

The user can insert the “OK” password (2 digits) or “Emergency” password (2 digits) (element 2 in the password screen photo depicted in FIG. 4).

The setting of “OK password” is obligatory in order for the RuOK Alert functionality to work, while the Emergency password is at the discretion of the user.

In the event that the user has inserted the OK password, then the application will return to the main “RUOK” screen. The Password screen will replace the main RuOK screen at the next time interval.

For example, if user activated the RuOK Alert on May 23, 2013 at 2:01 AM in the morning and set up a time interval of 1 minute. Then on May 23, 2013 at 2:02, the Password screen will show up and assuming the user inserted the OK Password, then the “Walk Me/ RuOK Alert screen” will return and after another minute has elapsed, the Password Screen will show up again.

In the password screen there is a timer (1 in FIG. 4) counting down the seconds for inserting the OK Password. For example, in FIG. 4, 26 seconds are remaining for insertion the password. The counting down timer is accompanied by beeps to refer user's attention for the need to insert the Password within the required time.

In the event that the OK password has not been inserted, or the user has inserted a password that is different from the OK or Emergency passwords (i.e. unidentified password), the system will give the user a second chance to insert the OK password. In the event the OK password will not be inserted after a second opportunity or an unidentified password has been inserted for the second time, the alarm status will be activated (including notice to server and notice by server to the Emergency Center and automatic call to the Emergency Center).

This means that once the RUOK Alert status has been activated, any damage to the mobile handset will not prevent from the system to notify the Emergency Center of the emergency situation.

In the event that Emergency password has been inserted, the mobile handset will appear to operate normally; i.e. as if OK password has been inserted; however the application will notify the server in a “silent” mode (without activating the Alarm functionalities) that user inserted an emergency password/signaled emergency status and the server will notify the Emergency Center.

Network Coverage Issues—System will alert user of Network coverage issues. The purposes of this alert is: (i) to avoid false emergency notices that are resulted from network coverage issues that prevented from the Server to get the “OK Password” notice; (ii) to notify user that server may not receive emergency password and the Emergency Center may not get the Emergency Center Call or Alarm call.

FIG. 5B demonstrates the flow of the system in the RuOK Alert mode.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method substantially as described hereinabove.

2. (canceled)

3. Apparatus substantially as described hereinabove.

4. (canceled)

5. A system substantially as described hereinabove.

6. (canceled)
